(19) United States
(12) Patent Application Publication
(10) Pub. No.: US 2006/0099387 A1
(43) Pub. Date: May 11, 2006

(54) Slip resistant component

(76) Inventors: Timothy H. Parkes, Ooltewah, TN (US); Erik E. Anderson, Cleveland, TN (US); John L. Brown, Ft. Oglethorpe, GA (US)

Correspondence Address: Kent R. Moore, P.C.;c/o Kent R. Moore, Esq., P.O Box 1026, Hixson, TN, 37343, US

(21) Appl. No.: 10/984,036

(22) Filed: Nov. 9, 2004

(51) Int. Cl. B32B 3/00

(52) U.S. Cl. 428/156; 428/120

(57) ABSTRACT

An improved slip resistant component comprising a new type of nib, called a cleat, for providing superior resistance to unwanted floor covering movement. The preferred cleat has a triangular profile and projects from the bottom surface of the mat at an angle. The cleat also is aligned in a particular direction to best resist the forces commonly encountered in a floor mat. There may be an array of cleats aligned in several directions in order to resist forces from virtually any direction. Other features of the present invention include contour lines to insure the floor covering conforms to the contour of the floor board (for automotive applications), an ergonomic heel pad for providing comfort to the heel, foot and leg of the driver, and a new cellular topography for catching and retaining dirt, debris and water.

### FIELD

The field of the present invention relates generally to a new component to provide for slip resistance for floor coverings, such as area rugs or floor mats, or other items placed on textile applications. In its preferred application the slip resistant component is applied to floor mats for automotive interior applications. Other features of the present floor mat are disclosed such as an ergonomic heel pad for superior heel cushioning for the user, cellular topography to hold water, dirt and debris for greater carpet protection, and form-fitting contour lines that are engineered to allow the mat to form with shape of the floor.

### BACKGROUND

In existing floor covering applications, slip resistance is typically a major concern. Floor coverings such as floor mats and area rugs must remain in place or they lose their protective value for the underlying surface. Additionally, if the covering moves, it can create a tripping hazard. Because existing floor coverings, such as floor mats, are designed primarily for foot and load traffic, most mats are purportedly designed to resist slipping or skidding to avoid slip and fall injuries and to prevent the covering from moving out of place. Slip-resistant mats also prevent wear and tear to the more expensive flooring beneath.

Using automotive floor mats as an example, in one existing mat configuration the underside of the mat is equipped with a series of nibs that extend from the bottom of the mat. The nibs are intended to intrude into the underlying carpet. However, it has been discovered that the existing nib configurations, because of the large number of nibs, often support the floor mat above the underlying carpet rather than penetrate into the carpet. Other existing nib designs are intended to mechanically adhere to the underlying floor structure (if a non-carpeted surface such as wood flooring), to prevent movement of the mat from foot traffic. Other designs include a fastener system (U.S. Pat. No. 6,068,908 to Kessler), a frame (U.S. Pat. No. 4,361,614 to Moffitt, Jr.), and suction cups (U.S. Pat. No. 6,014,779 to Lindholm).

Additionally, floor mat designs have not been adequately designed to fit to the form of the vehicle floorboard. Most existing floor mats are “generic” in design. That is, existing floor mats are manufactured in a single size to place in numerous vehicles. Because of the varying sizes of floorboards, these generic sizes do not provide the optimum fit. To compensate for the generic design, many floor mats are manufactured with trim lines. Trim lines allow the user to cut the mat along the predetermined lines in order for the perimeter of the mat to fit the floorboard of the vehicle as closely as possible. However, even if the perimeter of the mat is trimmed, the mat being generic in its overall shape simply does not conform to the contours of the floorboard.

There are many other features that existing floor mats do not include. For example, in a vehicle, the driver's foot can be postured in a number of positions that increase stress to the foot and lower leg make driving very uncomfortable. However, existing floor mats have not been designed to account for the comfort of the driver's foot. Finally, existing designs have not adequately accounted for the protection of the underlying carpet. Existing floor mats allow too much of the dirt, debris and water to run off onto the underlying carpet.

In general, past floor mat designs have not achieved the results that consumers have desired, that is, to adequately prevent travel of the mat, protect the underlying carpet and to provide comfort to the feet of the user. After extensive testing and analysis by the present inventor, a new design has been developed that achieves the above-noted objectives when incorporated into a floor mat or other floor covering product.

### SUMMARY

The present invention comprises a component for improving slip resistance in floor covering products that the present inventors believe provides significant advances over existing technology. First, the present slip resistant component includes a new design for a nib, referred to as a “cleat” in the present disclosure, which is attached to a substrate. The cleat has a unique shape concept that is designed to resist specific direction forces and maintain the floor covering in its intended position. Second, in connection with the new cleat design, the present slip resistant component includes contour lines in the floor covering itself that allow greater form fitting to the shape to the underlying surface. The contour lines are particularly useful in automotive interior floor mats due to the asymmetrical shape of most car floorboards. Because contour lines create a better fitting floor covering, it is less likely to move from its intended position. Other features disclosed include a cellular topography for a floor covering that traps dirt, debris and water and offers greater protection to the underlying carpet than any existing floor mat. Also disclosed is a new ergonomic design for an automotive floor covering that relieves the foot and lower leg of many of the stresses that are experienced while driving and thus provides greater comfort underfoot.

The slip resistant component of the present invention is a cleat that is attached to a substrate. The substrate has a top surface and a bottom surface and the cleat is attached to the bottom surface of the substrate. The cleat includes at least one edge or surface that protrudes at an acute angle relative to the bottom surface. By either placing the slip resistant component underneath a floor covering such as a floor mat, or attaching the slip resistant component to the underside of a floor covering, the floor covering will gain slip resistance that has not been achieved with prior inventions.

An important feature of the present invention is both the shape of the cleat and the angle at which the cleat protrudes from the bottom surface. The new design of the cleat can be utilized in a number of applications. For purposes of illustration only, the present disclosure will use the automotive environment. However, the reader should understand that the principles disclosed in this application may be applied to a variety of applications.

A typical floor mat comprises a substrate, such as rubber, EVA, vinyl, or other suitable substrate. The substrate has a top and bottom surface. The top surface (the area that accommodates the foot and load traffic) may be provided with carpeting or tufting, or may simply have a design formed into the top surface of the substrate either from a molding process or from a press process. The type of carpeting or design is commonly chosen to coordinate with the existing color scheme and to accommodate the anticipated loads.

In existing designs, when a person enters or exits an automobile, or during transit, the directional forces applied by the person's feet typically cause the floor mat to be moved out of its intended position. Most commonly for a driver or passenger, the mat is typically pushed diagonally and away from the person and toward the center and front of the vehicle floorboard. The end result is that the mat must be readjusted to its desired position.

The present applicant has researched the type of forces applied to floor mats in various situations. Likewise, the present applicant has conducted research regarding the shapes, sizes and orientations of the cleat that will best resist specific directional forces applied to floor mats in various situations. The slip resistant component of the present invention includes a cleat (or series of cleats) that protrudes from or is attached to the bottom surface of the floor mat at an acute angle relative to the plane of the mat and relative to the direction of the applied forces encountered by the mat. The multiple angular orientation of the cleat assists in resisting forces applied to the mat more than the typical “nib” of existing designs that protrude downwardly and perpendicularly from the bottom surface of the mat. In a preferred embodiment of the present invention, each cleat has a triangular-shaped profile. One leg of the triangular shaped cleat is a first edge. The first edge is disposed at an angle relative to the bottom surface such that the angle, when the floor mat is placed in position, assists in resisting the movement of the mat. Because the cleat is disposed at an angle, it is important to align the cleat in a direction that will oppose the anticipated force. Therefore, at least one cleat is preferably oriented on the bottom surface of the mat to directly oppose the forces encountered by the mat.

For example, in the illustration given previously, the driver's side floor mat tends to encounter certain forces when the driver enters and exits the vehicle. In one preferred embodiment of the present invention, at least one cleat would be oriented and aligned in such a manner to oppose the force tending to push the floor mat diagonally toward the center of the floorboard. In a particularly preferred embodiment, a series of cleats are placed in an array with each cleat having a different orientation. This particular arrangement provides stability not just in one direction but in multiple directions allowing even greater stay-in-place attributes.

In a particularly preferred embodiment, the sidewalls of each cleat are slightly convex in shape, that is, they each bow outward slightly. In contrast the top wall is convex in shape and bows inward slightly. It is this shape (as further illustrated in the drawings) that the present inventor has found through experimentation is the shape that is best suited to form the cleat of the present invention.

In a particularly preferred embodiment, one or more cleats are located on individual cells. The cells are located on the bottom surface of the mat and are preferably formed integrally with the mat. Each cell is flexible to assist in absorbing the forces applied to the mat so that the forces will move the flexible cell first before moving the cleat. The force absorption further helps to maintain the mat in its desired position.

The contour lines that allow the floor mat to form to the shape of the floor are an additional feature of the present disclosure. A floor mat may be manufactured with one or more breaks in the pattern of the mat. A thin area of the flexible substrate of the mat joins the area between the breaks in the pattern. Those breaks may be formed at any location on the mat but are preferably formed at or around the heal pad area where the floorboard of the vehicle begins to curve upward. The breaks in the pattern allow the mat to conform to the shape of the floorboard. The contour lines may work in conjunction with the cleats to allow superior traction on the floorboard to prevent slippage of the mat. Preferably, each contour line forms a complete break in the pattern of the floor mat so the mat can flex across the entire length of the contour line.

Another feature of the present invention is the ergonomic geometry that has been applied to a mat to increase the comfort underfoot for the passenger or driver. Studies have shown that changing the position of the heel can relieve some of the stress on both the feet and the lower leg of the driver. A mat that includes a raised heel pad area that not only accomplishes the change in position for the heel, and, thus, the entire foot, but also provides a cushioned area for the heel to rest. The heel pad may also include nibs or similar structure to prevent the foot from slipping.

An additional feature involves an improved cellular topography on the top portion of a mat for increased ability to retain water, dirt and other debris on the mat. Preferably, pockets or cells are formed on the mat to retain the water, dirt and debris. In a preferred embodiment, the cells are of varying depth to create an ergonomic topography. In another preferred embodiment, the mat comprises a border around the cells to trap any spillover that might occur from the cells. Moreover, in a particularly preferred embodiment, each cell corresponds to the cells located on the bottom surface of the mat on which the cleats are attached.

Other objects, advantages and capabilities of the present invention will become more apparent as the description proceeds, taken in conjunction with accompanying drawings, in which like parts have similar reference numerals.

### BRIEF DESCRIPTION OF THE DRAWINGS

FIG. 1 is a perspective view of a floor mat incorporating features of the present invention;

FIG. 2 is a side view of the embodiment shown in FIG. 1;

FIG. 3 is a top view of the embodiment shown in FIG. 1;

FIG. 4 is a bottom view of the embodiment shown in FIG. 1;

FIG. 5a is a side view of a preferred cleat of the present invention;

FIG. 5b is an end view of the cleat shown in FIG. 5a;

FIG. 5c is a top view of the cleat shown in FIG. 5b;

FIG. 5d is a perspective view of a preferred flexible cell of the present invention;

FIG. 6 is a perspective view of an array of cleats of the present invention;

FIG. 7a is a top view of a preferred embodiment of the contour line of the present invention;

FIG. 7b is a sectional view of the contour line shown in FIG. 7a;

FIG. 8 is a perspective view of a heel pad of the present invention; and

FIG. 9 is a perspective view of the cellular topography of the present invention.

### DETAILED DESCRIPTION

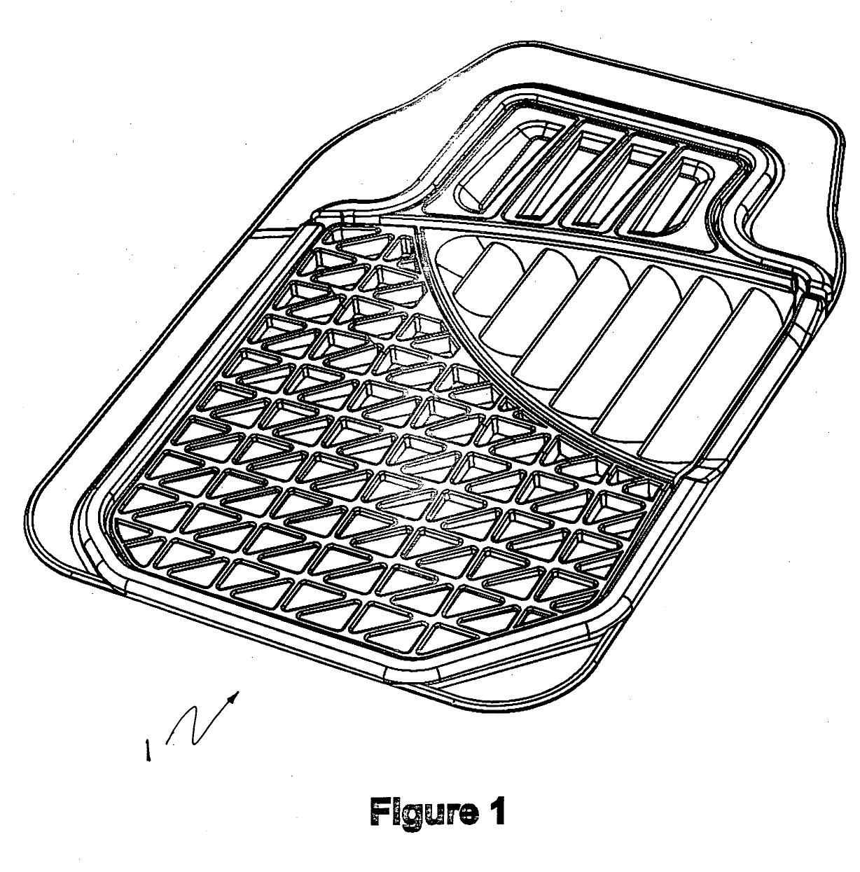

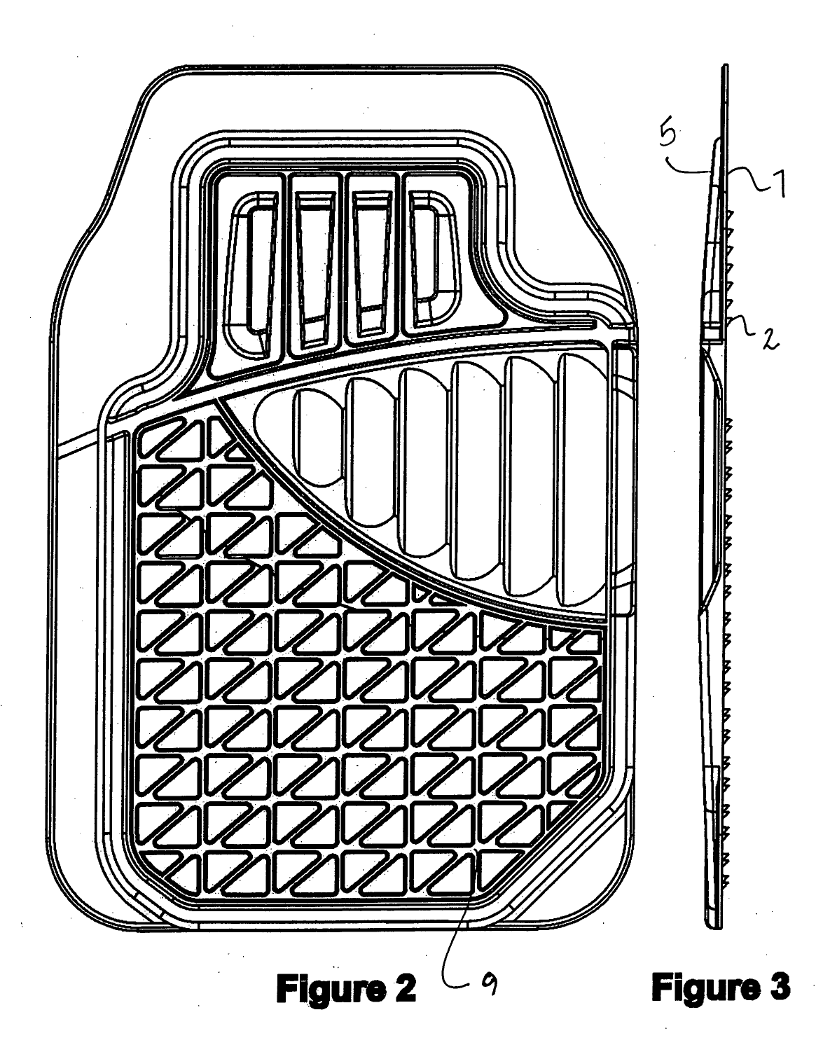

Referring to FIGS. 1-4, a floor covering 1 is shown incorporating a slip resistant cleat 2 of the present invention. The floor covering 1 shown and illustrated is a driver's side floor mat designed to cover the carpeted car interior under the driver's feet. However, the floor mat 1 may be any floor mat design used to cover a wide range of flooring surfaces for vehicles, boats, commercial or residential applications. The floor mat 1 is typically manufactured from a durable material such as rubber, EVA, vinyl, or other suitable material. The floor mat 1 has a top surface 5 and bottom surface 7. The top surface 5 is the area that accommodates the foot and load traffic. Therefore, the top surface 5 is commonly made of a material suitable for the type of anticipated traffic such as carpeting or tufting (not shown). Additionally, the top surface 5 may contain a pattern or design in part for decorative purposes and in part for providing slip resistant surface to reduce slip and fall incidents. The type of carpeting or design is commonly chosen to coordinate with the existing floor surface color and to accommodate the anticipated loads. If the top surface 5 is rubber or other moldable material, it may contain one or more designs 9 that have been pressed or formed into the top surface 5.

The present slip resistant cleat 2 may be designed for specific applications such as vehicle floor mats that encounter specific types of forces. For example, in a vehicle made for the United States market, the driver enters from the left side of the vehicle. When the driver's feet contact the driver's side floor mat, the directional forces applied by the driver's feet typically cause the floor mat to be pushed diagonally and away from the driver (toward the center front of the vehicle floor board). Other forces applied by the driver's feet, e.g. while driving, have a similar effect on the floor mat. The end result is the driver having to constantly readjust the floor mat to its desired position.

The present applicant has researched the type of forces applied to floor mats in various situations. Likewise, the present applicant has conducted research regarding a specific shape, size and orientation of cleat that will best resist specific directional forces applied to floor mats in various situations.

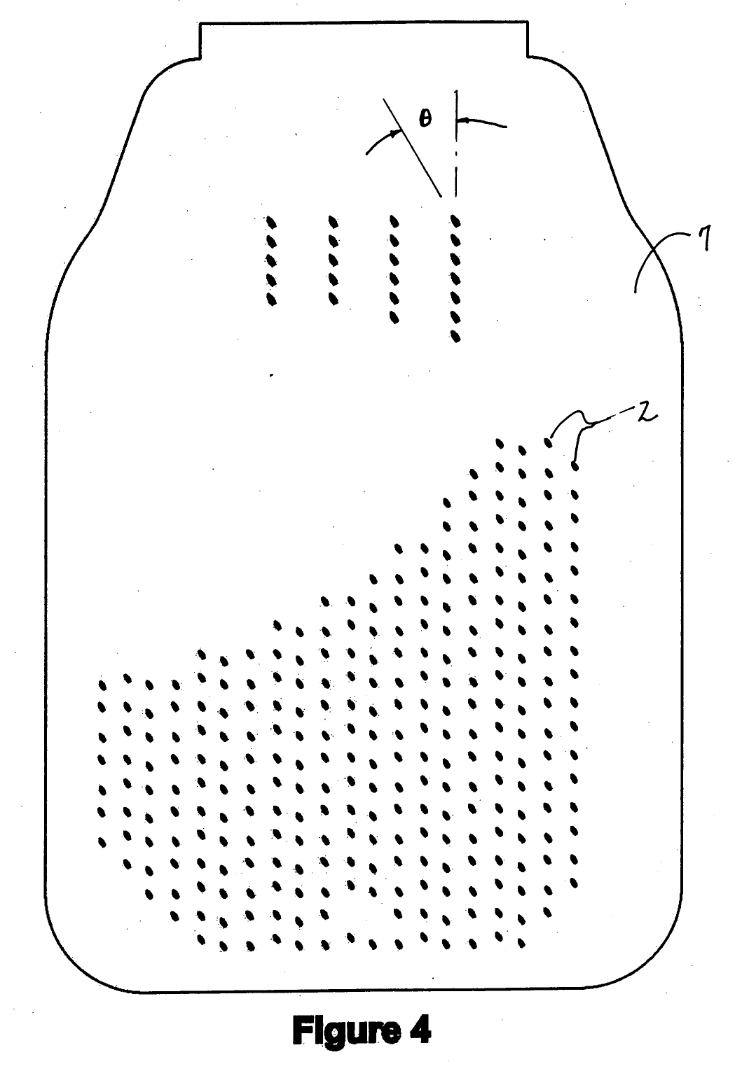

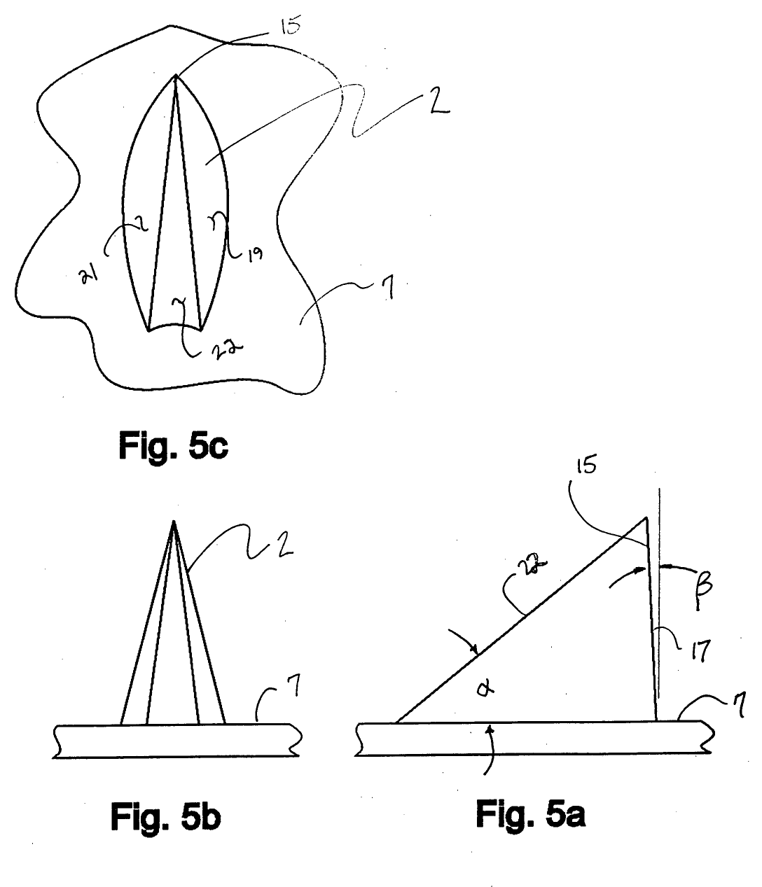

Referring to FIGS. 3-4, the bottom surface 7 of the floor mat 1 has a plurality of protruding slip resistant cleats 2 for penetrating the underlying carpet to prevent movement of the floor mat 1. The cleat 2 can be formed integrally with the mat 1 in processes such as injection molding or press molding. The cleat 2 also may be formed separately from the mat 1 and attached to one or more predetermined locations on the mat 1. Several important features of the present invention include the shape of the cleat 2, the angle at which the cleat 2 protrudes from the bottom surface 7 of the mat 1, and the orientation of the cleat 2 relative to the forces applied to the mat 1 and relative to every other cleat 2.

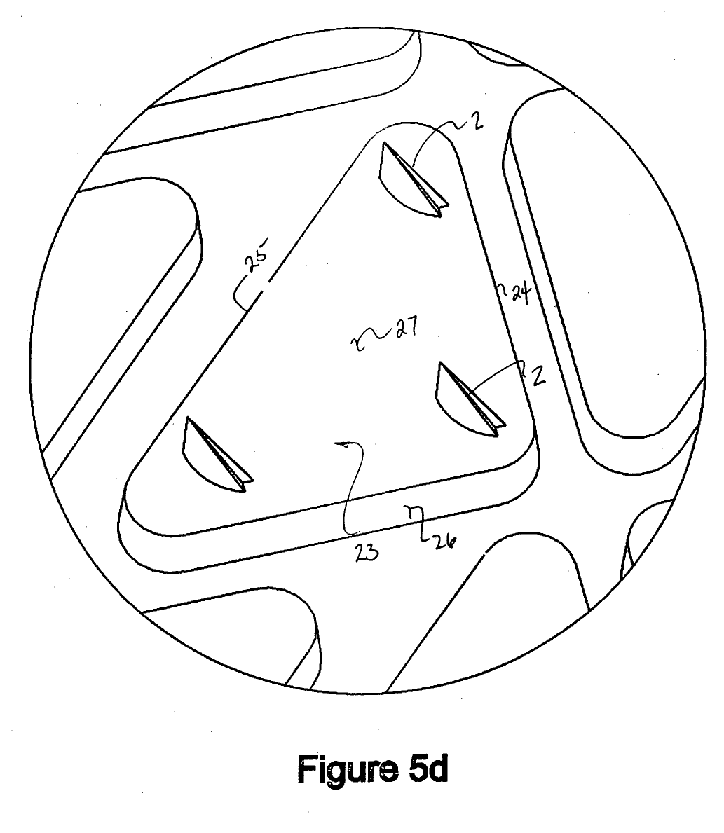

In general the cleat 2 of the present invention includes at least one edge or surface that protrudes at an acute angle relative to the bottom surface. This is in sharp contrast to existing floor mats where the nibs protrude perpendicularly from the bottom surface of the mat. As illustrated in FIGS. 5a, b, and c, the cleat 2 (or series of cleats) preferably protrudes from the bottom surface 7 of the floor mat 1 at an angle α. The angle of protrusion α of the cleat 2 assists in resisting forces applied to the mat 1 more than the typical “nib” of existing designs that protrude downwardly (perpendicular) from the bottom surface of existing mats. In a preferred embodiment of the present invention 1, each cleat 2 preferably has a first edge 15. The first edge 15 is disposed at an angle β relative to the bottom surface 7 such that the angle β, when the floor mat of the present invention 1 is placed in position, likewise further assists in resisting the movement of the mat. It is important to align the cleat 2 in a direction that will oppose the anticipated force. Therefore, the cleat is preferably oriented on the bottom surface 7 of the mat 1 in a manner that will directly oppose the forces encountered by the mat 1.

For example, in the illustration given previously, the driver's side floor mat tends to encounter certain forces when the driver enters and exits the vehicle. In one preferred embodiment of the present invention, the cleats 2 would be oriented and aligned at an angle θ. In a preferred embodiment, angle θ is 30 degrees, which, in experimentation conducted by your inventors, is the direction that a driver's side floor mat is likely to be pushed. With the cleat 2 oriented and aligned in the same direction the anticipated force, the cleat 2 is positioned to have the greatest tendency to resist the force being applied thus maintaining the mat of the present invention 1 in its desired position.

In a preferred embodiment, each cleat 2 is manufactured to have a certain mass of material behind the first edge 15 in order to have the necessary strength to resist the movement forces applied to the mat 1. In a particularly preferred embodiment, the cleat 2 has a triangular profile. The first edge 15 forms a first leg 17 of the triangle. Two triangular-shaped sidewalls 19, 21 extend away from the first edge 15. The sidewalls 19, 21 each connect to a single triangular-shaped top wall 22 and thus form the triangular shape of a preferred embodiment of the present invention 1.

In a particularly preferred embodiment, the sidewalls 19, 21 are slightly convex in shape, that is, they each bow outward slightly. In contrast the top wall 22 is concave in shape and bows inward slightly. It is this shape (as further illustrated in the drawings) that the present inventor has found through experimentation is the shape that is best suited to form the cleat 2 of the present invention. However, it should be noted that the present invention is not limited to a triangular shape to accomplish the objectives of the present invention.

Other arrangements of cleats are possible depending on the specifications of the floor mat 1. For example, a floor mat 1 of the present invention 1 designed for the passenger side of a vehicle would likely have a pattern of cleats 2 oriented in pattern having substantially a mirror image of the pattern of the driver's side cleats.

Referring to FIG. 5d, an alternate preferred embodiment of the cleat 2 of the present invention is shown. One or more cleats 2 may be attached to a cell 23. The cell preferably is manufactured from flexible materials such as rubber, and can be manufactured integrally with or separately from the rest of the floor mat 1. In the embodiment shown, each cell 23 has sidewalls 24, 25, 26, that extend from the bottom surface of the floor mat 1 and a cleat surface 27 that joins the sidewalls 24, 25, 26. By creating the flexible cell 23, when the floor mat 1 encounters a force, such as when a driver enters the vehicle, the flexibility of the cell 23 will absorb some of the applied force. Therefore, the force is not directly transferred to the underlying cleat 2. In other words, the force will first move the cell 23 or the cell sidewalls 24, 25, 26 before moving the cleat 2. In this preferred embodiment of the present invention, the force absorption provided by the combination of cleat 2 and cell 23 provides an anti-slip component that has not been achieved by any other existing design.

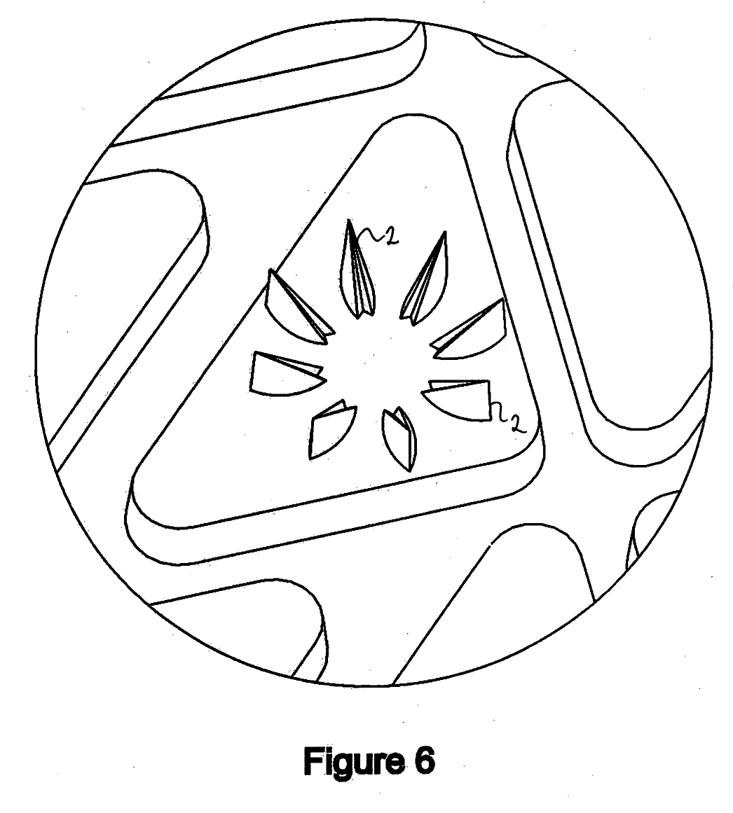

In a particularly preferred embodiment, as shown in FIG. 6, a series of cleats 2 are placed in an array with each cleat 2 having a different orientation. This particular arrangement provides stability not just in one direction, but also in multiple directions allowing even greater stay-in-place attributes.

The various embodiments of the cleat 2 may be affixed to the bottom surface 7 of a floor covering in a variety of ways. The cleat 2 may be integrally formed with the entire mat 1. Alternately, the cleats 2 may be manufactured separately and affixed to the mat 1 by any number of methods that are well known in the art and need not be discussed at length herein. For example, one or more cleats 2 may be manufactured on an underlayment that is then affixed to the bottom of the floor covering. However, a preferred method of attachment includes manufacturing holes (not shown) in predetermined locations on the bottom surface 7 of the mat 1. In a preferred embodiment, each cleat 2 would be attached to the surface 27 of the cell 23. Each cleat 2 is made with an auger (not shown) or similar device that corresponds to the holes in the bottom surface 7 (or cell surface 27) of the floor mat 1. The auger of the cleat 2 can be twisted into the mat 1 and securely affixed to the bottom portion of the mat 1. This particular embodiment allows the user to select the cleat design and the cleat location to suit his or her particular needs.

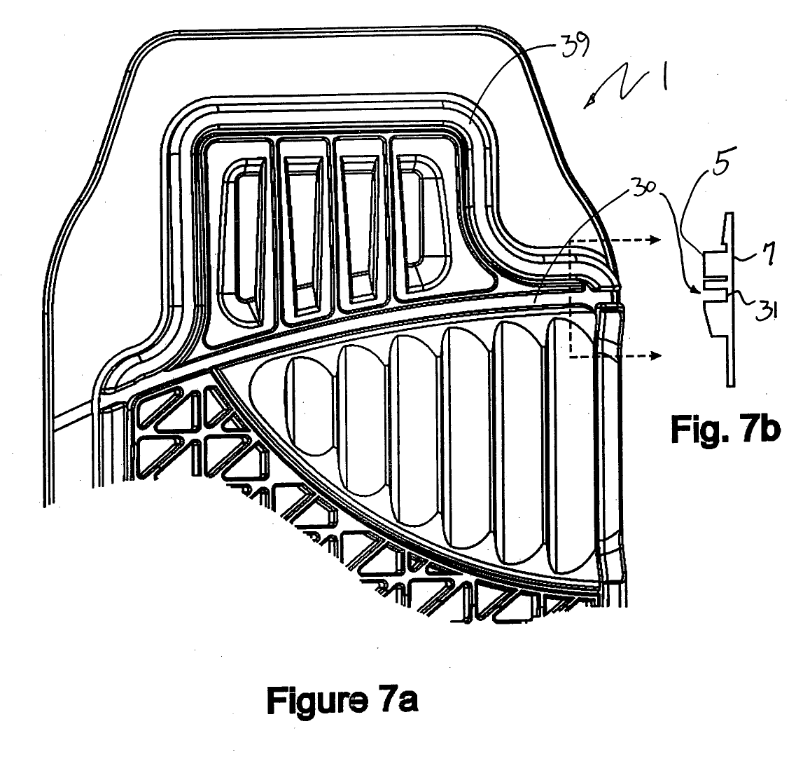

Referring to FIGS. 7a and 7b, the present invention also comprises one or more contour lines 30. The contour lines 30 are a thin portion of the flexible substrate 31 joining portions the bottom surface 7 of the floor mat 1 that allows for optimum flexibility of the floor mat 1. In an alternate embodiment, the flexible substrate 31 comprising the contour line 30 is molded so that it joins the top surface 5 of the floor mat 1. This upside down U-shape allows even greater flexibility in the contour lines 30. In a preferred embodiment, the contour lines 30 form a complete separation in the pattern of the top surface 5 of the floor mat 1 along the entire length of the contour line 30. In this configuration, the pattern on the top surface 5 does not prevent inhibit the full range of flexibility created by the contour lines 30. By utilizing the contour lines 30, a single floor mat can be placed in a wide range of vehicles and conform to the contour of the floorboard.

The contour lines 30 can be formed into the mat 1 by any number of conventional means. For example, in an all-rubber mat 1, the contour lines 30 are typically press molded. Preferably, the contour lines 30 are only a few millimeters wide and follow a specific pattern around the floor mat 1. In a particularly preferred embodiment, the contour lines 30 are manufactured in the floor mat 1 at or near the portions where the floorboard begins to curve upward. The contour lines 30 allow the mat to bend and to form to the shape of the floorboard. The contour lines 30 work in conjunction with the cleats 2 to allow superior traction on the floorboard to prevent slippage of the mat 1.

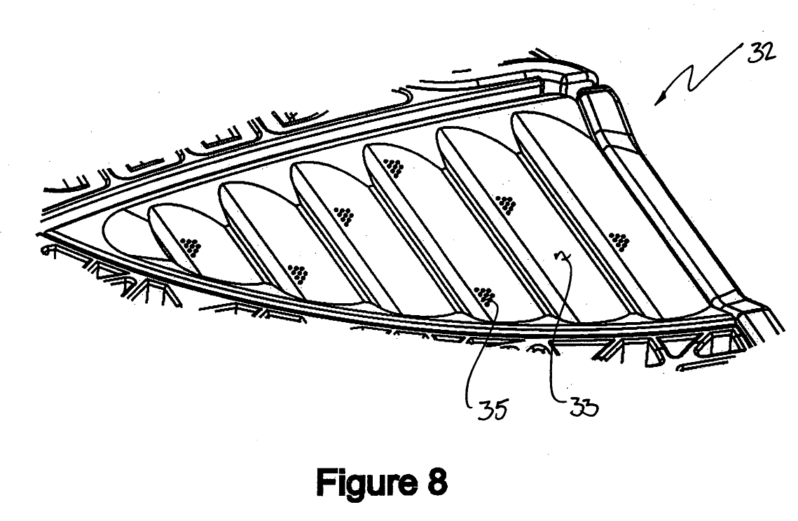

As shown in FIG. 8, the present invention includes a new ergonomic design for a floor mat 1. After extensive research regarding body mechanics, it was determined that raising the heel of a person seated in a vehicle, particularly of the driver, will cause a more natural posture for the entire foot. By creating a more natural posture for the foot, stress and strain on the entire leg, including the knee, is greatly reduced. In order to raise the heel, the floor mat 1 includes a heel pad 32 that is comprised of one or more heel pad areas 33. Each heel pad area 33 preferably is a soft, slightly raised, cushioned area to provide comfort for the heel and the rest of the leg. The types of materials and composition of the same are well known in the art and need not be discussed at length herein. The heel pad areas 33 may have any desired configuration. In a preferred embodiment illustrated in FIG. 7, the heel pad 32 comprises six separate heel pad areas 33 located on the floor mat 1 where the driver's right foot and heel (acceleration and braking) would typically rest. By providing more than one heel pad areas 33, the floor mat 1 provides two points of contact for the heel. This configuration prevents the heel from moving out of a comfortable position and provides more stability for the heel. Each heel pad area 33 in the embodiment shown has a top surface 34 with a convex or rounded contour. The heel pad 32 may raise the heel position from the floorboard by as much as almost two inches. The heel pad 32 provides a cushion for the heel and accomplishes a change in position for the heel, and, thus, the entire foot. Each raised heel pad area 33 may also include small nibs 35 or similar structure to prevent the foot from slipping.

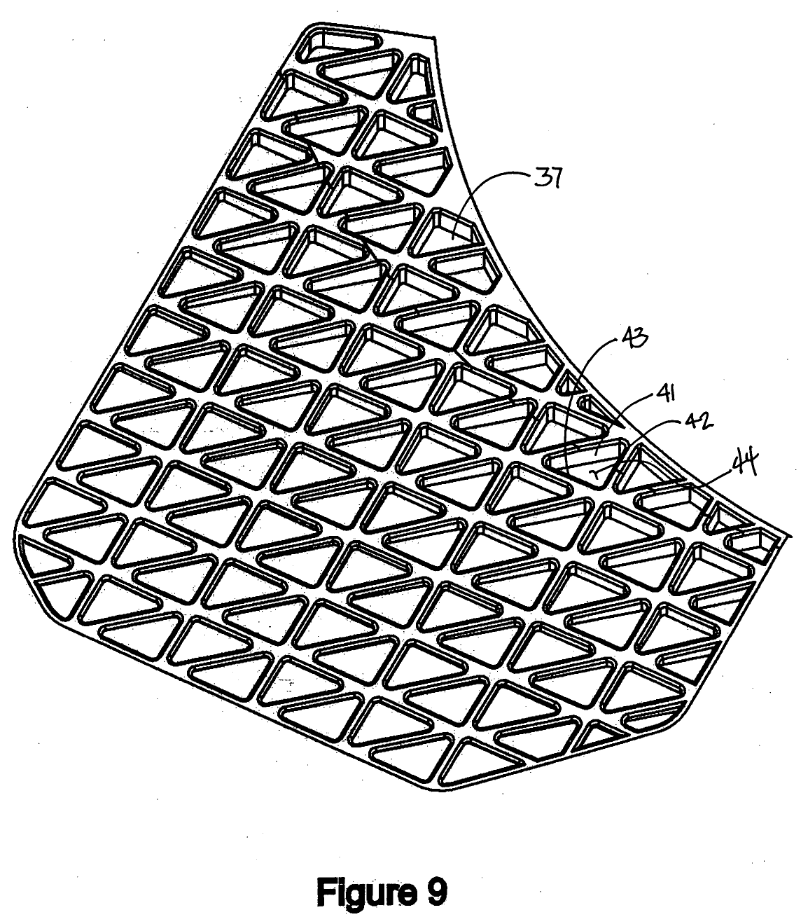

Referring to FIG. 9, an additional feature of the floor mat 1 involves an improved cellular topography on the top portion of the mat 1 for increased ability to retain water, dirt and other debris on the mat. Preferably, pockets or retention cells 37 are formed on the mat to retain the water, dirt and debris. In a preferred embodiment, the retention cells 37 are of varying depth to create an ergonomic topography. For example, the retention cells 37 located in the middle portion of the mat 1 would have a greater depth and thus correspond to the raised heel pad 32. Progressing toward the top portion and bottom portion of the mat 1, the retention cells 37 would gradually decrease in depth. In a particularly preferred embodiment, the mat 1 comprises a border 39 around the cells to trap any spillover that might occur from the retention cells 37, particularly any retention cell 37 near the bottom portion of the mat 1 that is not as deep and therefore, cannot retain as much debris as the retention cells 37 toward the middle portion of the mat 1.

In a particularly preferred embodiment, each retention cell 37 corresponds to a cleat cell 23. For example, side walls 41, 42, and 43 of the retention cell 37 would correspond to the side walls 24, 25, and 26 of a cleat cell 23. Bottom surface 44 of the retention cell 37 would correspond to the cleat cell surface 27.

Other objects, advantages and capabilities of the present invention will become more apparent as the description proceeds, taken in conjunction with accompanying drawings, in which like parts have similar reference numerals.

1. An improved slip resistant component for use on textile floor coverings comprising:
a. A substrate having a top portion and a bottom portion;
b. at least one cleat protruding from the bottom portion of the substrate.

2. The improved slip resistant component of claim 1 wherein said one cleat has a top edge that forms a first acute angle relative to the bottom portion.

3. The improved slip resistant component of claim 2 wherein said cleat further has a first edge connecting the bottom portion to the top edge.

4. The improved slip resistant component of claim 3 wherein said top edge is oriented at a second angle relative to the orthogonal plane that is perpendicular with the bottom portion.

5. The slip resistant component of claim 1 further comprising a plurality of cleats.

6. The slip resistant component of claim 2 wherein the top edge of each cleat is parallel with the top edge of every other cleat so that the plurality of cleats are all aligned in the same direction.

7. The slip resistant component of claim 3 wherein the cleat has a triangular profile.

8. The slip resistant component of claim 1 wherein the slip resistant component is attached to the underside of a floor mat.

9. The slip resistant component of claim 1 wherein said at least one cleat is attached to a cleat cell.

10. The slip resistant component of claim 9 wherein each cleat cell forms a corresponding retention cell on the top portion of the substrate.

11. The slip resistant component of claim 9 further comprising at least one contour line.

12. The slip resistant component of claim 9 wherein the cleat cell comprises a top wall and at least three side walls depending from said top wall, the cleat being positioned and attached to the top wall.
